(19) United States
(12) Patent Application Publication
(10) Pub. No.: US 2025/0371247 A1
(43) Pub. Date: Dec. 4, 2025

(54) OPTIMIZATION OF GENERATIVE AI SUMMARIZATION

(71) Applicant: Oracle International Corporation, Redwood Shores, CA (US)

(72) Inventors: Amir H. Rezaeian, San Mateo, CA (US); Vijayalakshmi Krishnamurthy, Santa Clara, CA (US)

(21) Appl. No.: 18/676,330

(22) Filed: May 28, 2024

(51) Int. Cl. G06F 40/166; G06F 40/40

(52) U.S. Cl. CPC G06F 40/166; G06F 40/40

(57) ABSTRACT

Techniques for optimizing generative AI summarization are provided. In one technique, a plurality of portions of text data is identified. For each portion of the plurality of portions, an embedding is generated based on that portion. Based on a plurality of embeddings that are generated for the plurality of portions, a plurality of clusters of embeddings is generated. For each cluster of embeddings of the plurality of clusters of embeddings, (1) a first language model generates a cluster summary based on portions, of the plurality of portions, that correspond to embeddings associated with that cluster of embeddings, and (2) the cluster summary is added to a set of cluster summaries. A second language model is used to generate a final summary based on the set of cluster summaries.

### TECHNICAL FIELD

The present disclosure relates generally to artificial intelligence and, more particularly, to generating a summary of a large corpus of text.

### BACKGROUND

Artificial intelligence (AI) systems have been developed to perform many different tasks, including generating summaries of text. Such summary generation is referred to herein as “summarization.” A difficulty arises when text to be summarized is greater than the context window of a large language model (LLM) that has been trained, using one or more machine learning techniques, to summarize text. The context window refers to the maximum length of input to an LLM in a single call to the LLM. If the size of text to be summarized is greater than the context window (e.g., four kilobytes or four thousand tokens), then the LLM must be called multiple times, where each call includes a different portion of the input text.

There are numerous challenges for summarizing large sets of data (e.g., a large corpus of documents) using a generative (Gen) AI system, including: (1) how to efficiently process high volume of documents in an effective way with low latency at inference time; (2) how to handle diversity of the input documents in summarization where different documents use different terminology, have conflicting information, and/or pertain to different topics; and (3) how to extract and combine information in an iterative fashion with low latency (at runtime) while at the same time guaranteeing the quality of summarization.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example summarization system that summarizes large corpora of text data, in an embodiment;

FIG. 2 is a block diagram that depicts an example map-reduce data flow for summarizing cluster summaries, in an embodiment;

FIG. 3 is a flow diagram that depicts an example process for summarizing a large corpus of input text data, in an embodiment;

FIG. 4 is a block diagram that illustrates a computer system upon which an embodiment of the invention may be implemented;

FIG. 5 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

A system and method for generating summaries of text using generative AI are provided. In one technique, embeddings of different portions of text data are generated. The embeddings are grouped or clustered based on similarity, resulting in a number of clusters. A summary is generated for each cluster, where some of the portions of the text data do not need to be summarized due to similarity to other portions of the text data that belong to the same cluster. For each cluster summary, an LLM generates a summary of that cluster summary, referred to as “partial” (or smaller) summaries. Then, for each set of multiple partial summaries, the set is input to an LLM to generate a cross-cluster summary. An LLM generates a final summary based on the cross-cluster summaries.

Embodiments improve computer-related technology related to generative AI, particularly to generating summaries. For example, embodiments reduce the latency of generating summaries because some portions of text data do not need to be summarized due to their duplicative nature. As another example, embodiments ensure that each topic in text data is reflected in the output.

### SYSTEM OVERVIEW

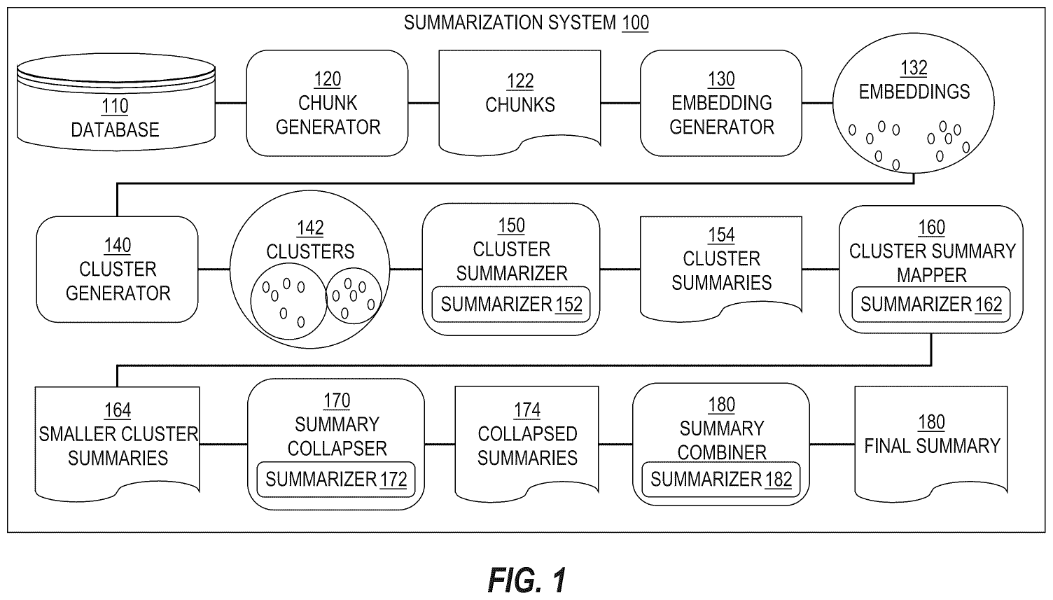

FIG. 1 is a block diagram that depicts an example summarization system 100 that summarizes large corpora of text data, in an embodiment. Summarization system 110 may be implemented as a cloud service (in a cloud) that requesters in the cloud or outside the cloud may access or to which requesters may submit summarization requests. A summarization request includes text data or a reference or link (e.g., a hypertext link) to a location where text data is stored. If a summarization request includes a reference or a link, then summarization system 100 retrieves the text data at the location (which may be local or remote relative to summarization system 100). Summarization system 100 may first authenticate the entity (e.g., user and/or client device) that submitted the summarization request.

Summarization system 100 includes a database 110 of text data, a chunk generator 120, an embedding generator 130, a cluster generator 140, a cluster summarizer 150, a cluster summary mapper 160, a summary collapser 170, and a summary combiner 180. Each of chunk generator 120, embedding generator 130, cluster generator 140, cluster summarizer 150, cluster summary mapper 160, summary collapser 170, and summary combiner 180 is implemented in software, hardware, or any combination of software and hardware.

### Database

Database 110 stores one or more corpora of text data. Each corpus of text data may comprise a single document or file or multiple documents or files. Each corpus of text data may originate from a client device (not depicted) that is communicatively coupled to summarization system 100. If a summarization request includes or references non-text data (e.g., audio data and/or image data), then summarization system 100 (or another component) generates text data based on the non-text data. For example, if the non-text data includes image data, then optical character recognition (OCR) may be performed on the image data to identify and extract text data that is embedded in the image data. As another example, if the non-text data includes audio data, then voice-to-text analysis is performed on the audio data to extract text data spoken by one or more voices detected in the audio data.

### Chunk Generator

Chunk generator 120 generates chunks of text from input text data (or corpus of text data). A chunk of text is a sequence of text and may be delimited by periods, paragraphs, or other punctuation. Additionally or alternatively, a chunk is determined based on size or number of (i) characters in a sequence of text or (ii) tokens associated with the sequence of text. Chunks that are generated by input text data may vary in size and/or other characteristics or attributes. For example, some chunks may be two sentences while other chunks may be three sentences and other chunks may be a single sentence. If input text data comprises multiple documents, then each chunk may be generated such that the text data of a chunk originates from a single document and, therefore, does not contain text data from two or more documents. This ensures that a chunk is likely to contain information about a single topic and not about multiple topics.

The output of chunk generator 120 is chunks 122, which are input to embedding generator 130.

### Embedding Generator

Embedding generator 130 generates an embedding for each chunk (of chunks 122) that is input to embedding generator 130. An embedding is a vector of values, each value corresponding to a different dimension of multiple dimensions. The size of an embedding (or number of values in an embedding) may vary from one implementation to another. Embedding generator 130 may have been trained on one or more corpora of text data. A feature of embedding generator 130 is that two embeddings that represent text that are closely related in training data will have embeddings that are relatively close together in the embedding space. For example, the embeddings for “canine” and “dog food” will be relatively close in the embedding space while the embeddings for “canine” and “software engineering” will be relatively far away from each other in the embedding space.

The output of embedding generator 130 is embeddings 132 (represented by small circles in FIG. 1), which are input to cluster generator 140.

### Cluster Generator

Cluster generator 140 generates multiple clusters (or groups) of embeddings based on embeddings 132. Thus, cluster generator 140 assigns each embedding to a single cluster or group. The text of embeddings that are in a single cluster are more likely to be related to each other (topic-wise or subject-wise) compared to text of embeddings that are in different clusters. Cluster generator 140 may generate a distance measurement between each embedding in embeddings 132 and one or more other embeddings in embeddings 132. Cluster generator 140 may then generate clusters based on these generated distance measurements.

Additionally, cluster generator 140 may take into account where two chunks (or two embeddings) originate in the input text data in determining whether the two embeddings should be assigned to the same cluster. For example, if two chunks originate from the same document, from the same section, from the same paragraph, or are consecutive/adjacent chunks in an input document, then the corresponding embeddings are more likely to be assigned to the same cluster.

The number of clusters that cluster generator 140 generates may vary depending on the size of the input text data and/or the number of documents in the input text data. For example, the larger the size of the input text data, the higher the number of clusters. However, there may be an upper limit on the number of clusters and, optionally, a lower limit on the number of clusters.

The output of cluster generator 140 is clusters 142 (which are represented, in FIG. 1, as the two circles that encompass different subsets of the small circles), which are input to cluster summarizer 150.

### Cluster Summarizer

Cluster summarizer 150 generates a summary of each cluster (referred to as a “cluster summary”). The first time that cluster summarizer 150 is invoked, cluster summarizer 150 accepts multiple chunks and a summarizer 152 within cluster summarizer 150 (e.g., an LLM) generates a summary based on the multiple chunks. A prompt to summarizer 152 may request that summarizer 152 generate a summary that is less than the context window of summarizer 152. The context window is the size of the largest possible input to summarizer 152. The prompt may specify an output size that is based on the context window, such as output size=“context window”−{a size of the next prompt}−{the size of the next chunk from the cluster in question}.

In an embodiment, the size of the initial set of chunks that is input to summarizer 152 is also equal to the context window of summarizer 152 or is based on the context window. Thereafter, for any cluster, after the first set of chunks of the cluster is input to summarizer 152, each subsequent input to summarizer includes the most recently-generated summary and one or more additional chunks (i.e., were not in any previous input to summarizer 152) from the cluster. Depending on the size of the most recently-generated summary and the size of the chunks that have not yet been added to the summary, each subsequent invocation of summarizer 152 may be with a different number of chunks than a prior invocation of summarizer 152. In other words, the number of chunks to summarizer 152 for the same cluster may vary from one invocation of summarizer 152 to another.

The output of cluster summarizer 150 is cluster summaries 154, which are input to cluster summary mapper 160.

### Refine Method

In an embodiment, cluster summarizer 150 includes a chunk sampler that samples (or selects) chunks from a cluster, iteratively invokes summarizer 152 in cluster summarizer 150 for each chunk, and generates one or more measurements to determine whether to invoke summarizer 152 with the most recent summary and another chunk. Thus, not all chunks of a cluster may be input to cluster summarizer 150. Avoiding the processing of each chunk in a cluster has two technical benefits: (1) it helps speed up the time until a final summary is generated for the input text data and (2) fewer computing resources are required to generate the final summary.

The chunk sampler selects chunks (from a cluster) for adding to a summary of the cluster in a certain order. That order is selecting chunks whose embeddings are closest to the center of the cluster. (The center of a cluster may be an average embedding of all embeddings in the cluster or may be the center-most embedding of all embeddings in the cluster.) Therefore, if all chunks of a cluster are eventually selected for generating a summary of the cluster, then the last chunk that would be selected is the chunk whose embedding is farthest away from the center of the cluster.

Example measurements that the chunk sampler include a similarity measurement and a quality measurement. Generating a similarity measurement may first comprise (1) generating an embedding of a summary that summarizer 152 of cluster summarizer 150 generates and (2) determining a “center embedding” of the cluster in question. A center embedding may be an embedding of a chunk (in a cluster) that is closest to the center among all embeddings in the cluster. Alternatively, a center embedding of a cluster may be an average of all embeddings in the cluster. A variation of this latter example is applying increasing weights to embeddings that are farther away from the center. For example, a first embedding that is twice as far away from an initial embedding compared to a second embedding will have half the weight as the second embedding. Thus, the contribution of the second embedding to the center embedding will be twice as high as the contribution of the first embedding to the center embedding.

If the difference between the embedding of the summary and the center embedding is below a certain pre-defined threshold, then no further chunks (from the cluster in question) are input to summarizer 152. Alternatively, one more chunk may be input to summarizer 152 along with the current summary. The prompt in this scenario may be different from previous prompts to summarizer 152 in that this latter prompt may specify or otherwise indicate a different output size, such as output size=“context window”−{the size of the next prompt}.

A variation of the similarity measurement is to compare (a) an embedding of a current summary for a cluster (which summary is based on a strict subset of chunks in the cluster) to (b) an embedding of the summary that was most recently generated (by the summarizer of cluster summarizer 150) before the current summary. If consecutive similarity measurements do not change very much (e.g., the difference between the consecutive similarity measures is below a certain threshold), then no more chunks are added to the summary of the cluster.

Regarding a quality measurement, a quality scorer (not depicted, within or separate from cluster summarizer 150) generates a quality score of a summary that summarizer 152 generates. A quality score measures quality of the generated text based on quality criteria such as readability, conciseness, brevity, consistency, grammar correctness, and other linguistic criteria. The quality scorer may be a machine-learned model (e.g., another LLM that is different than summarizer 152) that is trained to determine and generate a quality measurement of a summary. If two consecutive quality scores (generated for two different summaries for the same cluster) are very similar to each other (e.g., within a certain pre-defined threshold), then this indicates that the quality is not improving or changing. Therefore, no more chunks are added to the summary using summarizer 152.

In an embodiment, both the similarity measurement and the quality measurement must be under (or over, depending on the implementation) their respective thresholds before the chunk sampler of cluster summarizer 150 determines to add no more chunks from a cluster to a summary for that cluster.

In a related embodiment, the chunk sampler selects chunks to exclude from summarization if a chunk is very similar to (in terms of its embedding) (e.g., within a threshold distance of) an embedding of another chunk. Thus, if a group of embeddings are very similar to each other, then only one of those embeddings may be selected for summarizing and the other chunks may be ignored.

### Cluster Summary Mapper

Cluster summary mapper 160 generates a smaller cluster summary for each cluster summary from cluster summaries 154 that are input to cluster summary mapper 160. Thus, the number of smaller cluster summaries that cluster summary mapper 160 generates is equal in number to the number of cluster summaries that are input to cluster summary mapper 160.

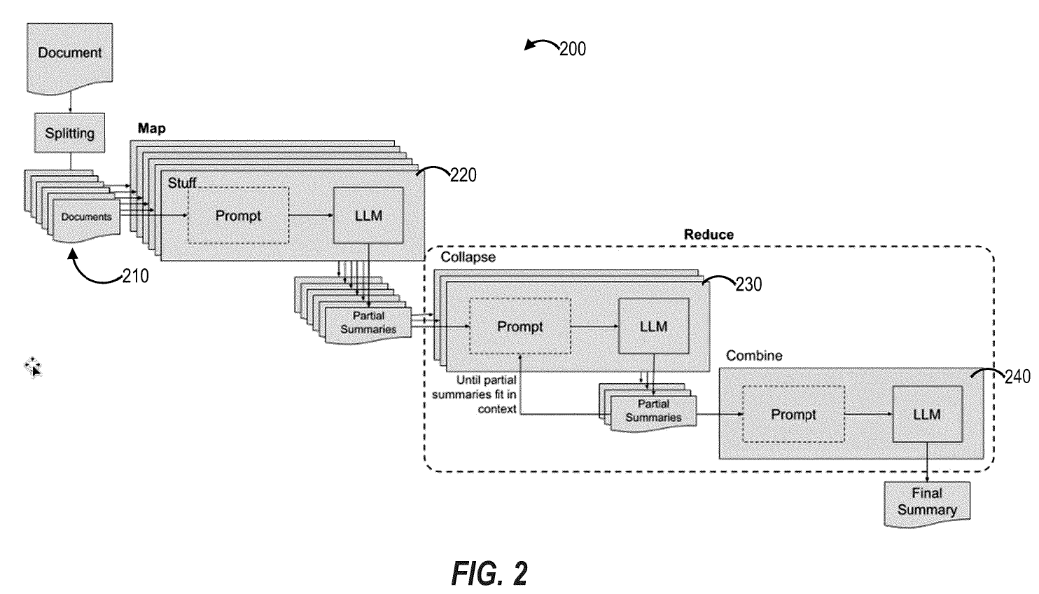

FIG. 2 is a block diagram that depicts an example map-reduce data flow 200 for summarizing cluster summaries 210, in an embodiment. Data flow 200 includes a reduce stage (multiple instances 220 of cluster summary mapper 160) and a reduce stage (comprising multiple instances 230 of summary collapser 170 and a single instance 240 of summary combiner 180), each of which is described in more detail hereafter.

Cluster summary mapper 160 includes a summarizer 162 and a prompt generator that generates prompts for summarizer 162. Summarizer 162 may be the same as summarizer 152. Alternatively, summarizer 162 and summarizer 152 may be different instances of the same summarizer. Alternatively, summarizer 162 and summarizer 152 may be LLMs that are trained based on different sets of training data. For example, summarizer 152 may be trained to generate output that is roughly the same size as the input to summarizer 152, whereas summarizer 162 may be trained to generate output that is much smaller than (e.g., half the size of) its input.

A prompt that is input along with a cluster summary from cluster summaries 154 is a prompt that requests that summarizer 162 to generate a summary that is smaller than the input cluster summary. The prompt may specify or otherwise indicate a multiple or ratio, such as “one half,” “⅓,” or “0.25” to indicate the size of the output cluster summary relative to the size of the input cluster summary. The size indication may be based on a context window of a summarizer of the next component (i.e., summary collapser 170) in summarization system 100.

The output of cluster summary mapper 160 is smaller cluster summaries 164, which are input to summary collapser 170.

### Summary Collapser

Summary collapser 170 takes two or more of smaller cluster summaries 164 as input and generates a collapsed summary that represents content from each of the input smaller cluster summaries. Summary collapser 170 includes a summarizer 172 that may be the same as or different than summarizer 162 or summarizer 152. Summarizer 172 is the first summarizer (in the data flow indicated in FIG. 1) that takes input summaries whose content originate from different clusters.

Similar to prompts to summarizer 162, a prompt to summarizer 172 may also specify or otherwise indicate a size of output of summarizer 172. The size indication may be based on a context window of a summarizer of the next component (i.e., summary combiner 180) in summarization system 100.

Summarizer 172 may be trained to retain, in the output, at least some content from each input summary. Also, the prompt to summarizer 172 may include instructions regarding how multiple input summaries can be summarized. For example, the prompt may specify an instruction on dropping duplicated summaries and retaining, from each summary, the most important parts, while ensuring the resulting summary is coherent and not missing any information, etc.

The output of summary collapser 170 is collapsed summaries 174. If the total size of collapsed summaries 174 is larger than the context window of summary combiner 180, then summarizer 172 is invoked again with a subset of collapsed summaries 174 in order to reduce the total size of the subset.

### Summary Combiner

Summary combiner 180 takes collapsed summaries 174 as input and generates a final summary 182. Summary combiner 180 includes a summarizer 182 (e.g., an LLM), which may be the same as summarizer 152, 162, and/or 172. The prompt that triggers summarizer 182 to generate final summary 182 does not need to indicate an output size limit on final summary 182 because final summary 182 is not input to another summarizer (or LLM). If the prompt specifies or otherwise indicates an output size of final summary 182, such an output size may be based on the wishes or desires of a user that is seeking summarization of the input text data. Such an output size may have been specified in the summarization request that ultimately resulted in the generation of final summary 182. In fact, the output size may be larger than the size of the input to summary combiner 180.

### “Infinite” Context Window

Even if a summarizer or LLM has a context window that is infinite or is so large that it can fit a large corpus of text data, embodiments would still generate higher quality summaries than such an “infinite” summarizer. In addition to summarizing, the summarizer would have to (a) ensure that duplicate information (including duplicative information that uses different terms to describe the same subject matter) is not summarized and (2) identify and remove other types of “noise,” such as irrelevant information. Embodiments reduce noise by (1) grouping chunks of text data based on their respective embeddings and (2) adding chunks that add substantively to a changing cluster summary.

### Process Overview

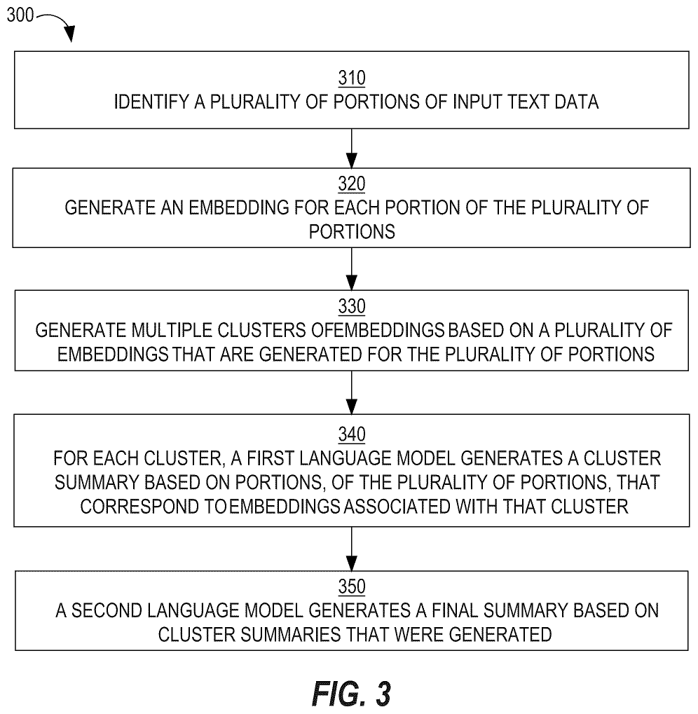

FIG. 3 is a flow diagram that depicts an example process 300 for summarizing a large corpus of input text data, in an embodiment. Process 300 may be implemented by different components of summarization system 100.

At block 310, a plurality of portions of the input text data is identified. Block 310 may be triggered by summarization system 100 receiving a summarization request that includes the input text data or at least a reference to one or more storage locations where the input text data is stored. Block 310 may involve identifying sentences or paragraphs in the input text data and, depending on the size of each sentence or paragraph, treating the sentence/paragraph as a chunk. Each chunk may be assigned a chunk identifier in order to distinguish one chunk from other chunks. Block 310 may be performed by chunk generator 120.

At block 320, an embedding is generated for each portion of the plurality of portions. Block 320 may be performed by embedding generator 130.

At block 330, based on a plurality of embeddings that are generated for the plurality of portions, multiple clusters of embeddings are generated. Block 330 may be performed by cluster generator 140.

At block 340, for each cluster, a first language model generates a cluster summary based on portions, of the plurality of portions, that correspond to embeddings associated with that cluster. Block 340 may be performed by cluster summarizer 150. Block 340 may be performed such that the portions associated with the center-most embeddings are selected first for summarizing by the first language model. Then, portions associated with embeddings that are next closest to the center of the cluster are selecting for adding to the summary.

Block 340 may involve computing a similarity measurement and/or a quality measurement and determining whether one or both measurements exceed a threshold. If so, then the cluster summary for the current cluster is considered sufficient and, if there are more clusters to consider, another cluster is selected for generating a cluster summary. If all clusters have been considered (and a cluster summary has been generated for each), then process 300 proceeds to block 350.

At block 350, a second language model generates a final summary based on the set of cluster summaries that were generated during execution of block 340. Block 350 may involve implementing a map-reduce technique.

For example, for each cluster summary in the set of cluster summaries, that cluster summary and a prompt to generate a smaller cluster summary is input to a summarizer (or LLM, which may be the same as the summarizer that generated the set of cluster summaries), which generates a smaller cluster summary of that cluster summary. The generated smaller cluster summary is input to a set of smaller cluster summaries, which is initially empty.

Then, for each subset in the set of smaller cluster summaries, the subset (e.g., two or three smaller cluster summaries) and a prompt to summarize (and reduce in size) the subset are input to a summarizer (or LLM, which may be the same as, or different than, one of the previously-mentioned summarizers). This is repeated for each distinct subset in the set of smaller cluster summaries. The result of each invocation of the summarizer given a subset may be referred to as a reduced subset. If the total size of the reduced subsets is greater than the size of the context window (or an offset of the size of the context window) of another (or the same) summarizer, then, for each subset of the reduced subsets, that subset and a prompt to summarize that subset (of the reduced subsets) are input to the summarizer. This is repeated until the total size of the reduced subsets is less than the size of the context window (or an offset thereof) of the other (or the same) summarizer.

Once the total size is less than the size of the context window (or an offset thereof), then the “final” reduced subsets are input to a “final” summarizer, which may be different than any of the prior summarizers or may be the same as one of the prior summarizers. A prompt that accompanies the final reduced subsets might not specify any size restriction/limit or may specify a size restriction/limit that is larger than the size of the context window of the final summarizer. This latter size restriction/limit may originate from the summarization request that triggered process 300.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

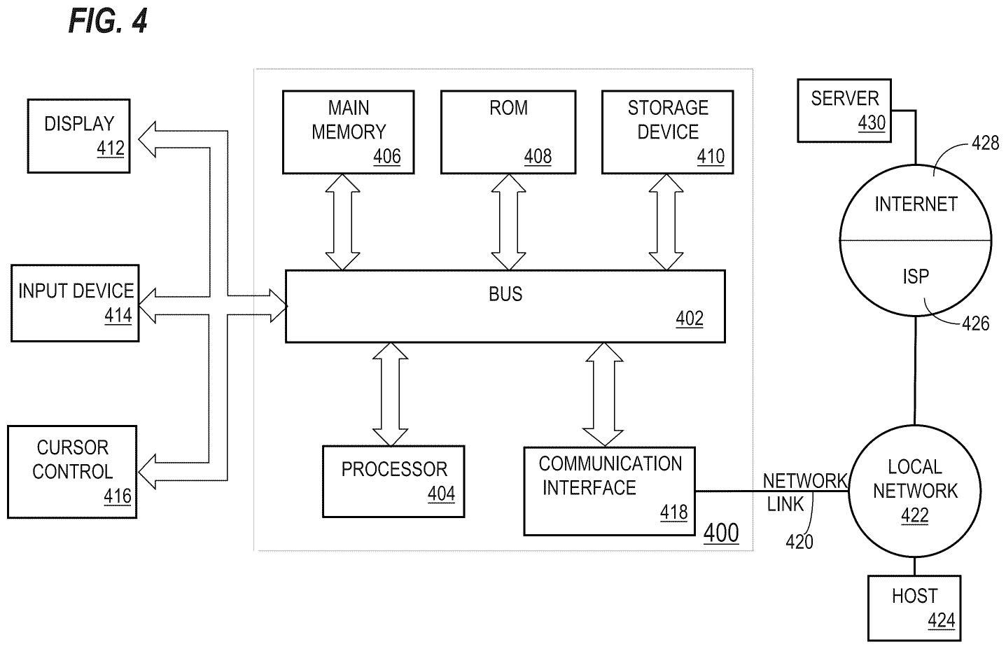

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic, or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic, or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

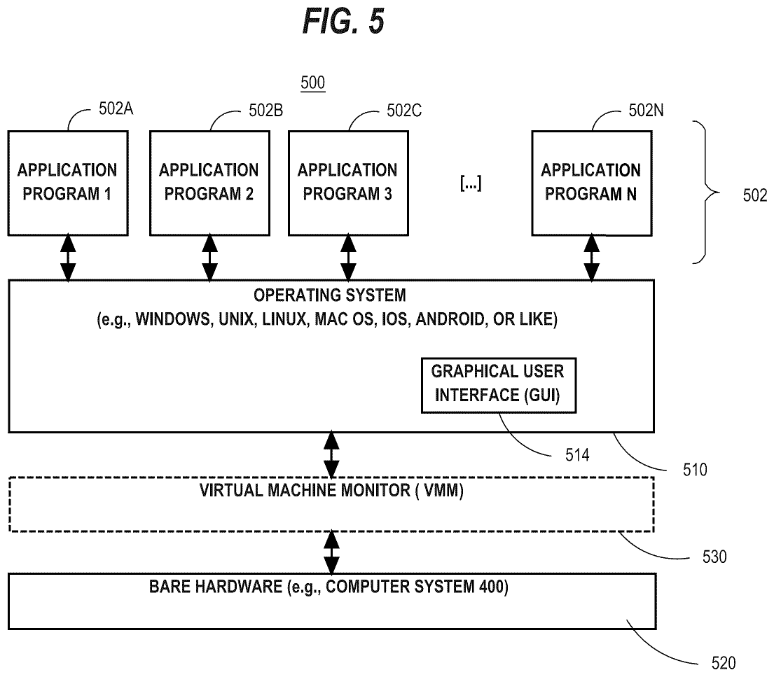

FIG. 5 is a block diagram of a basic software system 500 that may be employed for controlling the operation of computer system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computer system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
identifying a plurality of portions of text data;
for each portion of the plurality of portions, generating an embedding based on said each portion;
based on a plurality of embeddings that are generated for the plurality of portions, generating a plurality of clusters of embeddings;
for each cluster of embeddings of the plurality of clusters of embeddings:
generating, by a first language model, a cluster summary based on portions, of the plurality of portions, that correspond to embeddings associated with said each cluster of embeddings;
adding the cluster summary to a set of cluster summaries;
generating, using a second language model, a final summary based on the set of cluster summaries;
wherein the method is performed by one or more computing devices.

2. The method of claim 1, wherein the embeddings, associated with a first cluster of embeddings in the plurality of clusters of embeddings, upon which a first cluster summary is based is less than all embeddings that are associated with the first cluster embeddings.

3. The method of claim 1, further comprising:
for each cluster of embeddings of the plurality of clusters of embeddings:
selecting a first embedding in said each cluster of embeddings;
identifying a first portion, of the plurality of portions, that corresponds to the first embedding;
generating, by the first language model, a first summary of the first portion;
selecting a second embedding in said each cluster of embeddings;
identifying a second portion, of the plurality of portions, that corresponds to the second embedding;
generating, by the first language model, a second summary that is based on the first summary and the second portion;
determining whether to generate a subsequent summary based on another embedding in said each cluster of embeddings.

4. The method of claim 3, further comprising:
generating a particular embedding based on a third summary that is the second summary or is another summary that is based on the second summary;
identifying a center embedding in said each cluster of embeddings;
wherein determining whether to generate the subsequent summary is based on a comparison of the particular embedding and the center embedding.

5. The method of claim 3, further comprising:
generating, by a third language model that is different than the first language model, a first quality score based on the second summary;
generating, by the third language model, a second quality score based on a third summary that is based on the second summary;
wherein determining whether to generate the subsequent summary is based on the first quality score and the second quality score.

6. The method of claim 3, wherein selecting the first and second embeddings comprises selecting the first and second embeddings such that no other embedding in said each cluster of embeddings is closer to a center of said each cluster of embeddings than the first and second embeddings.

7. The method of claim 1, wherein generating the final summary based on the set of cluster summaries comprises:
for each cluster summary in the set of cluster summaries:
inputting, to a third language model, said each cluster summary and a first prompt to generate a smaller cluster summary;
in response to inputting the first prompt and said each cluster summary to the third language model, generating, by the third language model, the smaller cluster summary;
adding the smaller cluster summary to a set of smaller cluster summaries;
for each subset of the set of smaller cluster summaries:
inputting, to a fourth language model, the subset of the set of smaller cluster summaries and a second prompt to summarize the subset of the set of smaller cluster summaries, wherein the subset comprises two or more smaller cluster summaries;
in response to inputting the second prompt said each subset to the fourth language model, generating, by the fourth language model, a reduced subset.

8. The method of claim 7, wherein generating the final summary further comprises, after generating a set of reduced subsets:
inputting, to the second language model, the set of reduced subsets and a third prompt to summarize the set of reduced subsets;
wherein generating the final summary is performed in response to inputting the third prompt and the set of reduced subsets to the second language model.

9. One or more non-transitory storage media storing instructions which, when executed by one or more computing devices, cause:
identifying a plurality of portions of text data;
for each portion of the plurality of portions, generating an embedding based on said each portion;
based on a plurality of embeddings that are generated for the plurality of portions, generating a plurality of clusters of embeddings;
for each cluster of embeddings of the plurality of clusters of embeddings:
generating, by a first language model, a cluster summary based on portions, of the plurality of portions, that correspond to embeddings associated with said each cluster of embeddings;
adding the cluster summary to a set of cluster summaries;
generating, using a second language model, a final summary based on the set of cluster summaries.

10. The one or more storage media of claim 9, wherein the embeddings, associated with a first cluster of embeddings in the plurality of clusters of embeddings, upon which a first cluster summary is based is less than all embeddings that are associated with the first cluster embeddings.

11. The one or more storage media of claim 9, wherein the instructions, when executed by the one or more computing devices, further comprise:
for each cluster of embeddings of the plurality of clusters of embeddings:
selecting a first embedding in said each cluster of embeddings;
identifying a first portion, of the plurality of portions, that corresponds to the first embedding;
generating, by the first language model, a first summary of the first portion;
selecting a second embedding in said each cluster of embeddings;
identifying a second portion, of the plurality of portions, that corresponds to the second embedding;
generating, by the first language model, a second summary that is based on the first summary and the second portion;
determining whether to generate a subsequent summary based on another embedding in said each cluster of embeddings.

12. The one or more storage media of claim 11, wherein the instructions, when executed by the one or more computing devices, further comprise:
generating a particular embedding based on a third summary that is the second summary or is another summary that is based on the second summary;
identifying a center embedding in said each cluster of embeddings;
wherein determining whether to generate the subsequent summary is based on a comparison of the particular embedding and the center embedding.

13. The one or more storage media of claim 11, wherein the instructions, when executed by the one or more computing devices, further comprise:
generating, by a third language model that is different than the first language model, a first quality score based on the second summary;
generating, by the third language model, a second quality score based on a third summary that is based on the second summary;
wherein determining whether to generate the subsequent summary is based on the first quality score and the second quality score.

14. The one or more storage media of claim 11, wherein selecting the first and second embeddings comprises selecting the first and second embeddings such that no other embedding in said each cluster of embeddings is closer to a center of said each cluster of embeddings than the first and second embeddings.

15. The one or more storage media of claim 9, wherein generating the final summary based on the set of cluster summaries comprises:
for each cluster summary in the set of cluster summaries:
inputting, to a third language model, said each cluster summary and a first prompt to generate a smaller cluster summary;
in response to inputting the first prompt and said each cluster summary to the third language model, generating, by the third language model, the smaller cluster summary;
adding the smaller cluster summary to a set of smaller cluster summaries;
for each subset of the set of smaller cluster summaries:
inputting, to a fourth language model, the subset of the set of smaller cluster summaries and a second prompt to summarize the subset of the set of smaller cluster summaries, wherein the subset comprises two or more smaller cluster summaries;
in response to inputting the second prompt said each subset to the fourth language model, generating, by the fourth language model, a reduced subset.

16. The one or more storage media of claim 15, wherein generating the final summary further comprises, after generating a set of reduced subsets:
inputting, to the second language model, the set of reduced subsets and a third prompt to summarize the set of reduced subsets;
wherein generating the final summary is performed in response to inputting the third prompt and the set of reduced subsets to the second language model.

17. A system comprising:
one or more computing devices;
one or more non-transitory storage media storing instructions which, when executed by the one or more computing devices, cause:
identifying a plurality of portions of text data;
for each portion of the plurality of portions, generating an embedding based on said each portion;
based on a plurality of embeddings that are generated for the plurality of portions, generating a plurality of clusters of embeddings;
for each cluster of embeddings of the plurality of clusters of embeddings:
generating, by a first language model, a cluster summary based on portions, of the plurality of portions, that correspond to embeddings associated with said each cluster of embeddings;
adding the cluster summary to a set of cluster summaries;
generating, using a second language model, a final summary based on the set of cluster summaries.

18. The system of claim 17, wherein the embeddings, associated with a first cluster of embeddings in the plurality of clusters of embeddings, upon which a first cluster summary is based is less than all embeddings that are associated with the first cluster embeddings.

19. The system of claim 17, wherein the instructions, when executed by the one or more computing devices, further comprise:
for each cluster of embeddings of the plurality of clusters of embeddings:
selecting a first embedding in said each cluster of embeddings;
identifying a first portion, of the plurality of portions, that corresponds to the first embedding;
generating, by the first language model, a first summary of the first portion;
selecting a second embedding in said each cluster of embeddings;
identifying a second portion, of the plurality of portions, that corresponds to the second embedding;
generating, by the first language model, a second summary that is based on the first summary and the second portion;
determining whether to generate a subsequent summary based on another embedding in said each cluster of embeddings.

20. The system of claim 19, wherein the instructions, when executed by the one or more computing devices, further comprise:
generating a particular embedding based on a third summary that is the second summary or is another summary that is based on the second summary;
identifying a center embedding in said each cluster of embeddings;
wherein determining whether to generate the subsequent summary is based on a comparison of the particular embedding and the center embedding.
